(19) United States
(12) Patent Application Publication
(10) Pub. No.: US 2026/0128654 A1
(43) Pub. Date: May 7, 2026

(54) Linear Vibration Motor

(71) Applicant: AAC Microtech (Changzhou) Co., Ltd., Changzhou City (CN)

(72) Inventors: Weibo Chen, Changzhou (CN); Xiaorong Zhou, Changzhou (CN); Ziyang Zhang, Changzhou (CN); Keyang Wang, Changzhou (CN)

(21) Appl. No.: 19/174,898

(22) Filed: Apr. 9, 2025

Related U.S. Application Data
(63) Continuation of application No. PCT/CN2024/130466, filed on Nov. 7, 2024.

(51) Int. Cl. H02K 33/02; H02K 33/18

(52) U.S. Cl. CPC H02K 33/02; H02K 33/18; H02K 2211/03

(57) ABSTRACT

A linear vibration motor includes a shell, a vibration unit, a driving unit driving the vibration unit to vibrate, an insulating layer attached to the shell, and a flexible printed circuit board electrically connected with the driving unit. The vibration unit includes a magnet component. The driving unit is spaced apart from and directly opposite to the vibration unit, the driving unit includes a coil both fixed with the shell and the flexible printed circuit board by glue, the coil is electrically connected to the flexible printed circuit via a coil wire extending from the coil, the insulating layer is sandwiched between the coil wire and the shell. Compared with the related art, the linear vibration motor disclosed by the present disclosure could solve the phenomenon of poor insulation between the coil and the shell caused by the coil wire coming into direct contact with the shell.

### TECHNICAL FIELD

This invention relates to field of motors, specifically involving a linear vibration motor.

### BACKGROUND

A linear vibration motor is a machine that converts other forms of energy into mechanical motion, and are mainly used in a device which requires mechanical motion, such as a cell phone, a game console, and a flat panel with vibration capability.

The linear vibration motor mainly includes a shell, a vibration unit elastically supported in the shell, a driving unit fixed in the shell and driving the vibration unit to vibrate, and a flexible printed circuit board fixed in the shell and electrically connected to the driving unit.

The linear vibration motor mainly uses a magnet for the vibration unit and a coil for the driving unit, while the coil requires extended coil wires to be connected to the flexible printed circuit board in order to realize an electrical connection with the flexible printed circuit board.

The coil wires in the related technology are directly connected to the flexible printed circuit board, which is spaced from the shell. Although this design could avoid the phenomenon of poor insulation (poor conduction) caused by the coil and the shell due to the direct contact of the coil wires with the shell in a certain extent, the coil wires will still produce a certain movement when the linear vibration motor is running, which will cause the coil wires to come into direct contact with the shell, resulting in poor insulation between the coil and the shell.

Therefore, it is necessary to provide a linear vibration motor to solve the above problems.

### SUMMARY

The present disclosure is to provide a linear vibration motor which could solve the phenomenon of poor insulation between the coil and the shell caused by the coil wire coming into direct contact with the shell.

To achieve the above purpose, the present invention provides a linear vibration motor including a shell with an accommodating cavity, a vibration unit elastically supported in the accommodating cavity, a driving unit fixed in the shell and driving the vibration unit to vibrate, an insulating layer attached to the shell, and a flexible printed circuit board fixed in the accommodating cavity and electrically connected with the driving unit. The vibration unit includes a magnet component. The driving unit is spaced apart from and directly opposite to the vibration unit, the driving unit includes a coil both fixed with the shell and the flexible printed circuit board by glue, the coil is electrically connected to the flexible printed circuit via a coil wire extending from the coil, the insulating layer is sandwiched between the coil wire and the shell.

Further, the coil is in an annular shape, the flexible printed circuit board includes a main portion spaced apart from the coil and extending to outside of the shell, an annular portion fixed between the coil and the shell, and a connection portion connected with the main portion and the annular portion, the coil is attached to the annular portion, at least part of the coil is connected with the shell by glue.

Further, the flexible printed circuit board is provided with a through hole running therethrough, the through hole runs through the connection portion and/or the annular portion.

Further, the insulating layer is polyimide or a double-side adhesive.

Further, the vibration unit further includes a mass block elastically supported in the shell, the magnet component includes a first magnet group and a second magnet group, the first magnet group is fixed to a side of the mass block close to the coil, the second magnet group is fixed to a side of the mass block far away from the coil.

Further, the first magnet group includes three first magnets fixed with the side of the mass block close to the coil, the three first magnets are spaced apart in sequence along a vibration direction of the vibration unit, the second magnet group includes three second magnets fixed with the side of the mass block far away from the coil, the three second magnets are spaced apart in sequence along the vibration direction of the vibration unit, the three first magnets are arranged directly opposite to the three second magnets.

Further, a first groove is inwardly recessed from the side of the mass block close to the coil, a second groove is inwardly recessed from the side of the mass block far away from the coil, the first magnet group is fixed in the first groove, the second magnet group is fixed in the second groove.

Further, a first protruding portion is protruded and extended from a central region of the first groove, a middle magnet of the three first magnets is fixed to the first protruding portion, a second protruding portion is protruded and extended from a central region of the second groove, a middle magnet of the three second magnets is fixed to the second protruding portion.

Further, the driving unit further includes an iron core fixed in the shell, the coil is wound around the iron core and spaced apart from the shell.

Further, the shell is in a rectangular shape, the linear vibration motor further includes two elastic members, two opposite sides of the vibration unit are supported on two opposite sides of the shell by the two elastic members.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a linear vibration motor in accordance with an exemplary embodiment of the present invention.

FIG. 2 is an exploded view of the linear vibration motor in accordance with an exemplary embodiment of the present invention.

FIG. 3 is an isometric view of a first perspective of a flexible printed circuit board and a coil of the linear vibration motor in accordance with an exemplary embodiment of the present invention.

FIG. 4 is an isometric view of a second perspective of the flexible printed circuit board and the coil of the linear vibration motor in accordance with an exemplary embodiment of the present invention.

FIG. 5 is a cross-sectional view of the linear vibration motor taken along line A-A in FIG. 1.

### DETAILED DESCRIPTION OF THE EMBODIMENTS

The following will be taken in conjunction with the accompanying drawings of embodiments of the present invention, the technical scheme in the embodiment of the invention is clearly and completely described, obviously, the described embodiments are merely part of the embodiments of the present invention, and not all embodiments are based on the embodiments of the present invention, and all other embodiments attained by those of ordinary skill in the art without inventive effort are within the scope of the present invention.

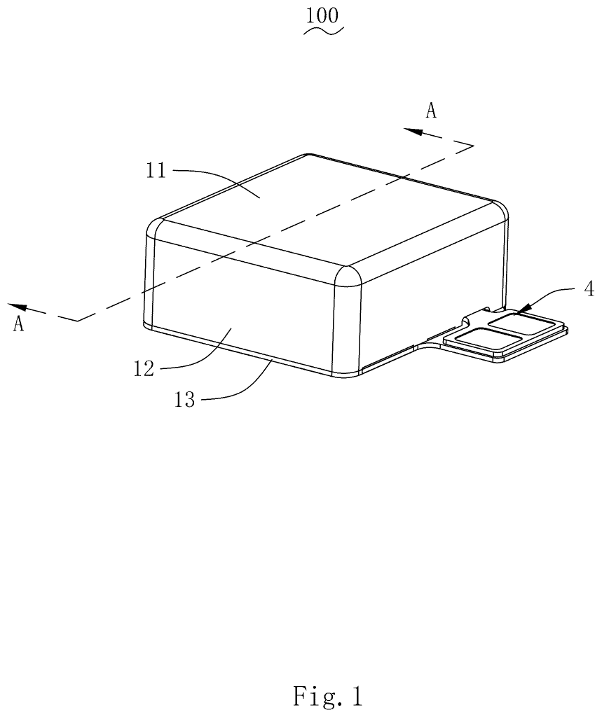

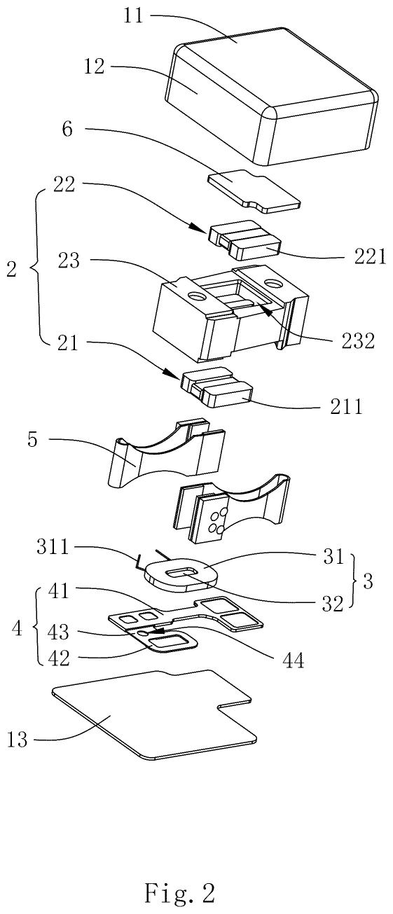

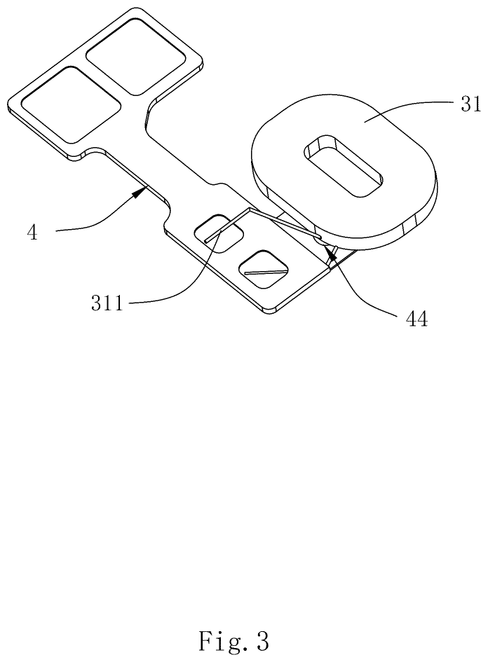

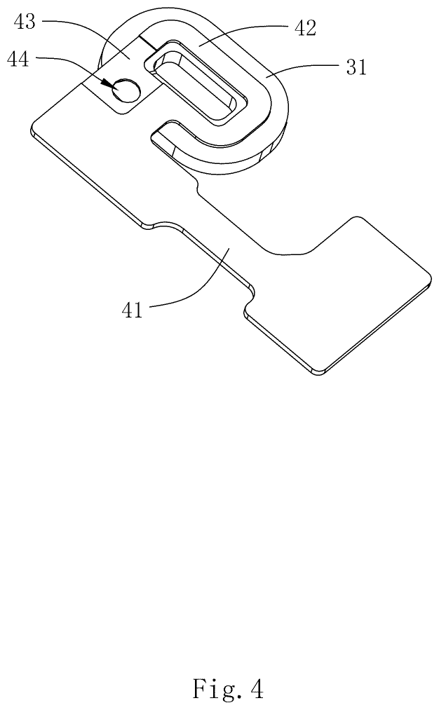

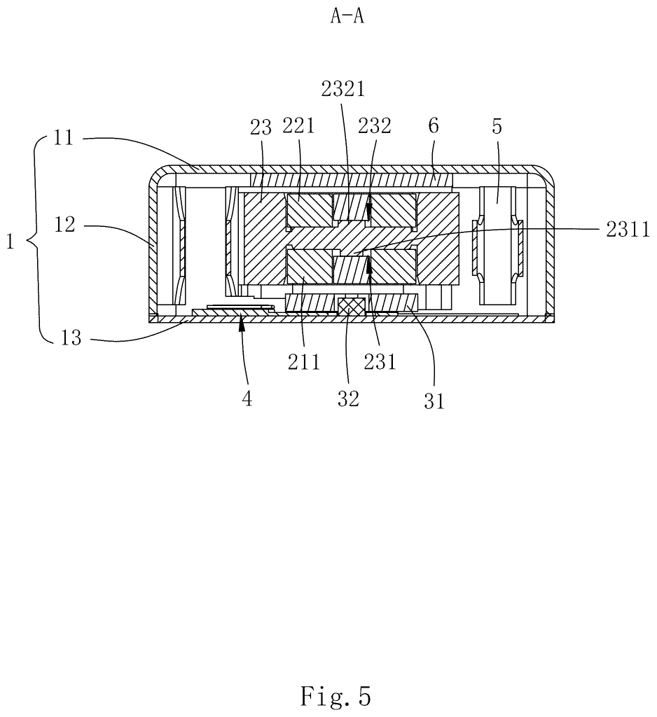

Please refer to FIGS. 1-5, the present invention provides a linear vibration motor 100 including a shell 1 with an accommodating cavity, a vibration unit 2 elastically supported in the accommodating cavity, a driving unit 2 fixed in the shell 1 and driving the vibration unit 2 to vibrate, and a flexible printed circuit board 4 fixed in the accommodating cavity and electrically connected with the driving unit 3, the driving unit 3 is spaced apart from and directly opposite to the vibration unit 2.

The shell 1 is in a rectangular shape, the shell 1 includes a bottom plate 11, a side plate 12 bent and extended from a peripheral edge of the bottom plate 11, and a cover plate 13 covered with the side plate 12, the bottom plate 11, the side plate 12, and the cover plate 13 are jointly enclosed to form the accommodating cavity, the vibration unit 2 is elastically supported by the side plate 12, the driving unit 3 and the flexible printed circuit board 4 are fixed with the cover plate 13 respectively.

The driving unit 3 includes a coil 31, the vibration unit 2 includes a mass block 23 elastically supported in the shell 1 and a magnet component fixed with the mass block 23, the magnet component includes a first magnet group 21 and a second magnet group 22, the first magnet group 21 is fixed to a side of the mass block 23 close to the coil 31, the second magnet group 22 is fixed to a side of the mass block 23 far away from the coil 31.

A first groove 231 is inwardly recessed from the side of the mass block 23 close to the coil 31, a second groove 232 is inwardly recessed from the side of the mass block 23 far away from the coil 31, the first magnet group 21 is fixed in the first groove 231, the second magnet group 22 is fixed in the second groove 232.

The first magnet group 21 includes three first magnets 211 fixed with the side of the mass block 23 close to the coil 31, the three first magnets 211 are spaced apart in sequence along a vibration direction of the vibration unit 2, the second magnet group 22 includes three second magnets 221 fixed with the side of the mass block 23 far away from the coil 31, the three second magnets 221 are spaced apart in sequence along the vibration direction of the vibration unit 2, the three first magnets 211 are arranged directly opposite to the three second magnets 221.

A first protruding portion 2311 is protruded and extended from a central region of the first groove 231, a middle magnet of the three first magnets 211 is fixed to the first protruding portion 2311, a second protruding portion 2321 is protruded and extended from a central region of the second groove 232, a middle magnet of the three second magnets 221 is fixed to the second protruding portion 2321.

The shell 1 is in a rectangular shape, the linear vibration motor 100 further includes two elastic members 5, two opposite sides of the vibration unit 2 are elastically supported on two opposite sides of the shell 1 by the two elastic members 5. In addition, the two elastic members 5 are fixed with the side plate 12 of the shell 1. Each of the two elastic members 5 is a V-shaped shrapnel, and according to the actual demand, it could also be a U-shaped shrapnel, spring, elastic silicone, or elastic rubber, and so on.

The coil 31 of the driving unit 3 is both fixed with the shell 1 and the flexible printed circuit board 4 by glue, the coil 31 is electrically connected to the flexible printed circuit board 4 via a coil wire 311 extending from the coil 31. The linear vibration motor 100 further includes an insulating layer attached to the shell 1, the insulating layer is sandwiched between the coil wire 311 and the shell 1.

The driving unit 3 further includes an iron core 32 fixed in the shell 1, the coil 31 is wound around the iron core 32 and spaced apart from the shell 1. In the present embodiment, the iron core 32 is fixed with the cover plate 13.

The coil 31 is in a ring shape, the flexible printed circuit board 4 is fixed with the shell 1 by glue flowing from the coil wire 311. The flexible printed circuit board 4 includes a main portion 41 spaced from the coil 31 and extending to outside of the shell 1, an annular portion 42 fixed between the coil 31 and the shell 1, and a connection portion 43 connected with the main portion 41 and the annular portion 42, the coil 31 is attached to the annular portion 42, at least part of the coil 31 is connected with the shell 1 by glue. A portion of a side of the coil 31 close to the flexible printed circuit board 4 and exposed to the flexible printed circuit board 4 is fixed to the shell 1, since the flexible printed circuit board 4 is fixed to the shell 1 by the glue flowing out of the coil wire 311, the coil wire 311 is also fixed with the connection portion 43 and the main portion 41 of the flexible printed circuit board 3. That is, the coil wire 311 of the coil 31 is fixed with the flexible printed circuit board 4 by the glue, the flexible printed circuit board 4 is fixed with the shell 1 by the glue flowing out of the coil wire 311, also the coil wire 311 is fixed with the shell 1 by glue. Therefore, the contact area between the coil 31 and the shell 1 could be increased which could enhance the strength of the adhesive bond between the coil 31 and the shell 1. The number of the coil wire 311 is two, the two coil wires are fixed with the connection portion 43 and the main portion 41 respectively.

Further, the flexible printed circuit board 4 is fixed with the cover plate 13 of the shell 1.

The flexible printed circuit board 4 is provided with a through hole 44 running therethrough, the through hole 44 runs through the connection portion 43 and/or the annular portion 42. In this way, this design ensures that the glue on the coil wire 311 flows between the flexible printed circuit board 4 and the cover plate 13 to increase the contact area between the flexible printed circuit board 4 and the shell 1, thereby the strength of the adhesive bond between the coil 31 and the shell 1 could be enhanced.

The insulating layer is polyimide or a double-side adhesive.

The liner vibration motor 100 further includes a pad 6 fixed with a side of the bottom plate 11 close to the mass block 23 and arranged directly opposite to the mass block 23.

Compared with the related technology, in the embodiment, the coil wire 311 extending from the coil 31 is fixed with the shell 1 and the flexible printed circuit board 4 by the glue, the insulating layer is attached to the shell 1, therefore, the coil wire 311 and the shell 1 will be insulated by means of the glue and the insulating layer, and thus solve the phenomenon of poor insulation between the coil 31 and the shell 1 caused by the coil wire 311 coming into direct contact with the cover plate 13.

The foregoing is merely illustrative of embodiments of the present invention, and it should be noted that modifications may be made to those skilled in the art without departing from the spirit of the invention but are intended to be within the scope of the invention.

What is claimed is:

1. A linear vibration motor comprising:
a shell with an accommodating cavity;
a vibration unit elastically supported in the accommodating cavity, comprising a magnet component;
a driving unit fixed in the shell and driving the vibration unit to vibrate;
an insulating layer attached to the shell; and
a flexible printed circuit board fixed in the accommodating cavity and electrically connected with the driving unit; wherein
the driving unit is spaced apart from and directly opposite to the vibration unit, the driving unit comprises a coil both fixed with the shell and the flexible printed circuit board by glue, the coil is electrically connected to the flexible printed circuit via a coil wire extending from the coil, the insulating layer is sandwiched between the coil wire and the shell.

2. The linear vibration motor as described in claim 1, wherein the coil is in an annular shape, the flexible printed circuit board comprises a main portion spaced apart from the coil and extending to outside of the shell, an annular portion fixed between the coil and the shell, and a connection portion connected with the main portion and the annular portion, the coil is attached to the annular portion, at least part of the coil is connected with the shell by glue.

3. The linear vibration motor as described in claim 2, wherein the flexible printed circuit board is provided with a through hole running therethrough, the through hole runs through the connection portion and/or the annular portion.

4. The linear vibration motor as described in claim 1, wherein the insulating layer is polyimide or a double-side adhesive.

5. The linear vibration motor as described in claim 1, wherein the vibration unit further comprises a mass block elastically supported in the shell, the magnet component comprises a first magnet group and a second magnet group, the first magnet group is fixed to a side of the mass block close to the coil, the second magnet group is fixed to a side of the mass block far away from the coil.

6. The linear vibration motor as described in claim 5, wherein the first magnet group comprises three first magnets fixed with the side of the mass block close to the coil, the three first magnets are spaced apart in sequence along a vibration direction of the vibration unit, the second magnet group comprises three second magnets fixed with the side of the mass block far away from the coil, the three second magnets are spaced apart in sequence along the vibration direction of the vibration unit, the three first magnets are arranged directly opposite to the three second magnets.

7. The linear vibration motor as described in claim 6, wherein a first groove is inwardly recessed from the side of the mass block close to the coil, a second groove is inwardly recessed from the side of the mass block far away from the coil, the first magnet group is fixed in the first groove, the second magnet group is fixed in the second groove.

8. The linear motor as described in claim 7, wherein a first protruding portion is protruded and extended from a central region of the first groove, a middle magnet of the three first magnets is fixed to the first protruding portion, a second protruding portion is protruded and extended from a central region of the second groove, a middle magnet of the three second magnets is fixed to the second protruding portion.

9. The linear motor as described in claim 8, wherein the driving unit further comprises an iron core fixed in the shell, the coil is wound around the iron core and spaced apart from the shell.

10. The linear motor as described in claim 1, wherein the shell is in a rectangular shape, the linear vibration motor further comprises two elastic members, two opposite sides of the vibration unit are supported on two opposite sides of the shell by the two elastic members.
